(19) United States
(12) Patent Application Publication
(10) Pub. No.: US 2025/0349147 A1
(43) Pub. Date: Nov. 13, 2025

(54) HUMAN THREE-DIMENSIONAL (3D) SURFACE ESTIMATION WITH CORRECTION FOR PERSPECTIVE

(71) Applicant: Hinge Health, Inc., San Francisco, CA (US)

(72) Inventors: Kai Ahmed, Montreal (CA); Sohail Zangenehpour, Beaconsfield (CA); Colin Joseph Brown, Saskatoon (CA); Louis Harbour, Montreal (CA)

(21) Appl. No.: 19/273,528

(22) Filed: Jul. 18, 2025

Related U.S. Application Data
(63) Continuation of application No. PCT/US24/12551, filed on Jan. 23, 2024.
(60) Provisional application No. 63/481,586, filed on Jan. 25, 2023.

(51) Int. Cl. G06V 40/10; G06T 7/11; G06T 15/20; G06T 17/20

(52) U.S. Cl. CPC G06V 40/103; G06T 7/11; G06T 15/205; G06T 17/20; G06T 2207/20132

(57) ABSTRACT

Introduced here are computer-implemented platforms (also referred to as “pose monitoring platforms”) that are designed estimate human three-dimensional (3D) surface with correction for perspective. A pose monitoring platform can access a digital image comprising a two-dimensional (2D) representation of the human 3D surface and extract a plurality of contiguous pixels. The platform can include a neural network, which can perform various operations on the contiguous pixels. In some embodiments, the operations can include: (i) generating a segmentation map that includes the extracted contiguous pixels, (ii) generating a plurality of joint heatmaps corresponding to the 2D representation of the human 3D surface, (iii) generating a plurality of feature maps corresponding to the extracted contiguous pixels in the segmentation map, and (iv) based on the plurality of feature maps, generating a 3D mesh that approximates the human 3D surface.

### CROSS-REFERENCE TO RELATED APPLICATION

This application is a continuation of International Application No. PCT/US2024/012551, titled “Human Three-Dimensional (3D) Surface Estimation with Correction for Perspective” and filed on Jan. 23, 2024, which claims priority to U.S. Provisional Application No. 63/481,586, titled “Human Three-Dimensional (3D) Surface Estimation with Correction for Perspective” and filed on Jan. 25, 2023, each of which is incorporated by reference herein in its entirety.

### TECHNICAL FIELD

Various embodiments concern computer programs designed to improve performance of poses with various body parts and associated systems and methods.

### BACKGROUND

Exercise therapy is an intervention technique that utilizes physical activity as the principal treatment method for addressing the symptoms of musculoskeletal (MSK) conditions, such as acute physical ailments and chronic physical ailments. Exercise therapy programs may involve a plan for performing physical activities during exercise therapy sessions that occur on a periodic basis. Generally, the purpose of an exercise therapy program is to either restore normal MSK function or reduce the pain caused by an acute or chronic physical ailment, which may have been caused by injury or disease. As such, the physical activities to be performed in each exercise therapy session may be selected in order to achieve a specific therapeutic goal. Examples of therapeutic goals include lessening pain, improving flexibility, rehabilitating injuries, managing diseases, and the like.

These exercise therapy programs normally depict how a user should perform one or more physical activities to achieve a specific therapeutic goal within a time period. However, exercise pose monitoring platforms usually are unable to monitor whether the user is properly performing the physical activities. For example, if the user is not using the proper technique to perform a physical activity, she may not experience improvement in her acute or chronic pain, flexibility, or the like, causing the user to become discouraged from doing her exercise therapy sessions. Therefore, a better approach is needed for monitoring poses to ensure that users are able to achieve lasting improvement in terms of MSK function. The benefits of improved performance of poses are not limited to exercise therapy programs.

Other systems that facilitate training a user to perform physical activities may also be unable to monitor whether a user is properly performing a variety of physical activities, such as dance moves, sporting techniques, exercises, cooking techniques, and the like. For example, if a user is not using proper form for her forehands, she may not be as successful in tennis matches compared to if she were using proper form. In another example, a user may be penalized in a cooking competition for not cutting her vegetables in a specific manner, and a system could have informed her with the ability to monitor her cutting technique. Thus, these systems need a way to monitor physical activities for users to achieve improved form.

Physical activities can be monitored and documented by capturing digital images (or simply “images”). Images generated by cameras with large fields of view can cause a targeted person to appear warped and distorted, however. This distortion can be more visible in pixels farther from the center of the image. In a T-pose and/or an A-pose, the head, hands and feet can be positioned far from the center of the image and therefore can be the most distorted parts of the body in the image. The distortion can be more extreme when the image is cropped. For example, the region around the head can have a different distortion level compared to the region around the feet. In monocular three-dimensional (3D) human surface estimation performed using photographic images, the distortion in the two-dimensional (2D) photo of a person can translate into a distorted 3D estimated surface.

### BRIEF DESCRIPTION OF THE DRAWINGS

FIG. 1 illustrates an example of a network environment that includes a pose monitoring platform.

FIG. 2A illustrates an example of a computing device able to implement a program in which a user is requested to perform physical activities, such as exercises, during sessions by a pose monitoring platform.

FIG. 2B illustrates an analysis module of the pose monitoring platform of FIG. 2A, where the analysis module is structured to facilitate 3D surface estimation with correction for perspective.

FIG. 3A depicts an example of a communication environment that includes a pose monitoring platform configured to receive several types of data, where the data can be used to facilitate 3D surface estimation with correction for perspective

FIG. 3B depicts another example of a communication environment that includes a pose monitoring platform configured to obtain data from one or more sources, where the data can be used to facilitate 3D surface estimation with correction for perspective.

FIG. 4A depicts a block diagram of a process for facilitating human 3D surface estimation with correction for perspective in a pose monitoring platform.

FIG. 4B depicts X-, Y-, and Z-coordinate dimensional maps used in human 3D surface estimation with correction for perspective in a pose monitoring platform.

FIG. 4C depicts a flow diagram of a process for facilitating human 3D surface estimation with correction for perspective in a pose monitoring platform.

FIG. 5 depicts a block diagram illustrating an example of a processing system in which at least some operations described herein can be implemented.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Introduced here are computer-implemented platforms that are designed to improve adherence to, and success of, care programs that are assigned to users for completion. A care program (or simply “program”) may be designed for one or more musculoskeletal (MSK) conditions. As an example, a program may be designed in an effort to address (e.g., alleviate or lessen) the pain that tends to accompany a given MSK condition, as well as facilitate the continued engagement that is critical for long-term success. Specifically, the program may instruct, prompt, or otherwise elicit performance of physical activities that are meant to improve different aspects of the given MSK condition. Examples of physical activities include exercises, stretches, and the like.

As part of a program, a user may be requested to engage with a computer-implemented platform (also referred to as a “pose monitoring platform”) that is accessible via a computer program executing on a computing device. The term “user” may be used to generally refer to an individual who engages in physical activities via the pose monitoring platform. Over time, the user may be instructed to perform physical activities during physical activity sessions (or simply “sessions”) as part of a program. For example, the user may be instructed to perform a series of physical activities over the course of a session, and the user may be prompted to complete a series of sessions over the course of several days, weeks, or months. The pose monitoring platform may not only assist the user by actively guiding her through each session, but also help her achieve and maintain proper technique in performing the physical activities.

As further discussed below, a pose monitoring platform may represent one part of the physical activity system (or simply “system”) that is designed to promote compliance with a program by determining estimating poses performed by users via computer vision techniques. Though referred to in relation to therapeutic activities herein, the pose monitoring platform may promote programs with physical activities for a variety of activities beyond healthcare, such as for wellness, sports, dance, virtual reality, augmented reality, cooking, art, or any other endeavor that requires physical activities be performed in a particular manner (or simply benefits from physical activities being performed in a particular manner). More detailed examples of how monitoring pose can be helpful in different contexts are provided below.

Generally, the pose monitoring platform described herein is embodied as a computer program executing on a computing device that is accessible to a user. This computing device may be coupled to one or more image sensors that capture image data about the environment surrounding a user. As the user completes physical activities during a session, the computing device sends image data captured by these image sensors to the pose monitoring platform for computer vision analysis. By analyzing this image data, the pose monitoring platform may be able to establish whether the user is performing the physical activities as requested (e.g., by determining poses of body parts). This approach is lightweight and can be applied on a previously-cropped image patch, which only marginally increased the total runtime of the pose estimation model compared to a model that does not employ a secondary branch. Moreover, the approach is dedicated to determining body part presence or absence and therefore provides a complementary signal to keypoint detection confidence. Such an approach enables the pose monitoring platform to provide personalized feedback to a user about the physical activities that the user has performed. Moreover, the pose monitoring platform may tailor a program (or individual sessions) based on its knowledge of user movement. For example, if the pose monitoring platform determines that a user struggled to perform a physical activity (e.g., based on determined body poses), then the pose monitoring platform may issue further instructions to the user of how to properly perform the physical activity. At a high level, the pose monitoring platform is representative of a pathway for digitally engaging users in a consistent, meaningful way. As further discussed below, other avenues of communication may be employed as well. For example, a coach may be able to interact directly with users (e.g., via text messages, email, video, etc.) in addition to communicating with those users through the pose monitoring platform. The term “coach” may be used to generally refer to individuals who prompt, encourage, or otherwise facilitate engagement by users with programs. Similarly, users could be connected with healthcare professionals such as physical therapists, physicians, nurses, counselors, etc. For example, the pose monitoring platform may generate interfaces through which a coach can serve as a guide, partner, or “cheerleader” for a user as she completes sessions in accordance with a program. Similarly, the pose monitoring platform may generate interfaces through which a healthcare professional can obtain or rely on advice regarding symptoms, treatment, and the like.

As mentioned above, the approaches introduced here for estimating pose could be used across different applications. Accordingly, while embodiments may be described in the context of healthcare, features of those embodiments may be similarly applicable to other fields related to performing physical activities. Similarly, while embodiments may be described in the context of “coaches,” features of those embodiments may be similarly applicable to other professionals. In addition to, or instead of, facilitating communication with coaches and healthcare professions, the pose monitoring platform could facilitate communication with athletes, athletics coaches, dance instructors, chefs, cooking instructors, art instructors, and the like.

Certain embodiments described herein are related to computer programs designed to facilitate human 3D surface estimation with correction for perspective. The human 3D surface can be estimated based on a 2D image-based representation of the human 3D surface, and a pose represented by the estimated human 3D surface can be determined by the pose monitoring platform.

For the purpose of illustration, embodiments may be described with reference to particular anatomical regions, sensor data analysis techniques, pose applications (e.g., dance, therapy, sports, etc.), and the like. However, those skilled in the art will recognize that the features are similarly applicable to other anatomical regions, computer vision techniques, and use cases. As an example, while embodiments may be described in the context of an image sensor that captures image data about the environment around a user, the features described herein may be applied by a physical activity system having any number of image sensors arranged throughout the environment. In fact, a pose monitoring platform may establish the spatial position of different anatomical regions over time and then determine whether those spatial positions indicate that the physical activities were performed properly. For example, an image sensor that is embedded in a computing device (e.g., a mobile phone or tablet computer) may be used for capturing image data of a user playing a virtual reality game, or an image sensor may be affixed to the top of a television for capturing image data of a user playing a virtual reality game. The pose monitoring platform may be able to infer whether the user dodged monsters in the virtual reality game based on the image data captured by the image sensor. In another example, two image sensors may be placed in a kitchen, one above the island and the other above the stove. The pose monitoring platform may use image data of a user's hands captured by either sensor to determine if a user is using proper technique when chopping and sauteing zucchini. The pose monitoring platform may employ any number of computer vision techniques for determining body poses in these scenarios. Examples of computer vision techniques include image classification, object detection, object tracking, semantic segmentation, and instance segmentation.

Moreover, embodiments may be described in the context of computer-executable instructions for the purpose of illustration. However, aspects of the technology can be implemented via hardware, firmware, or software. As an example, a pose monitoring platform may be embodied as a computer program that offers support for completing sessions as part of a program, enables communication between users and coaches, and determines which physical activities are appropriate for a session given past performance, specified preferences, etc.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

### Overview of Pose Monitoring Platform

As discussed above, a pose monitoring platform may be responsible for guiding a user through sessions that are performed as part of a program. As part of the program, the user may be requested to engage with the pose monitoring platform on a periodic basis. The frequency with which the user is requested to engage with the pose monitoring platform may be based on factors such as the anatomical region for which therapy is needed, the MSK condition (or non-healthcare related condition, such as desire to improve technique) for which therapy is needed, the difficulty of the program, the age of the user, the amount of progress that has been achieved, and the like.

The pose monitoring platform may perform three-dimensional (3D) pose estimation, where a pose comprises 3D locations in an image of joints in a body (e.g., elbows) and of body parts (e.g., face, hands, etc.). For accuracy, the pose monitoring platform performs pose estimation in a top-down manner by detecting body part instances in an image, cropping the body part instances out of the image, and processing the crops using a model.

As mentioned above, the pose monitoring platform may estimate pose in contexts that are unrelated to healthcare, for example, to improve technique. For example, the pose monitoring platform may estimate pose of an individual while she completes an athletic activity (e.g., dancing, shooting a basketball, throwing a baseball), a virtual reality activity, an augmented reality activity, a cooking activity, an art activity, etc. Accordingly, while embodiments may be described in the context of a “user,” the features of those embodiments may be similarly applicable to individuals performing physical activities. These individuals may also be referred to as “users” of the pose monitoring platform.

Even if the pose monitoring platform is able to request that a user engage at a given frequency, the user will normally have the autonomy to engage with the program as frequently as she desires. Thus, the user may define a schedule for completing sessions (e.g., every day, every other day, or twice per week) as further discussed below, and various features of the pose monitoring platform may be designed in support of this habit formation. Alternatively, the user may complete sessions on an ad hoc basis.

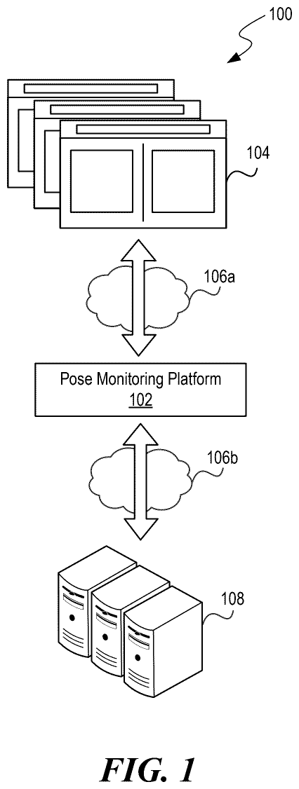

FIG. 1 illustrates an example of a network environment 100 that includes a pose monitoring platform 102. Individuals can interact with the pose monitoring platform 102 via interfaces 104 as further discussed below. For example, users may be able to access interfaces that are designed to guide them through sessions, present educational content, indicate progression in a program, present feedback from coaches, etc. As another example, coaches may be able to access interfaces through which information regarding completed sessions (and thus program progression) and clinical data can be reviewed, feedback can be provided, etc. Thus, interfaces 104 generated by the pose monitoring platform 102 may serve as informative spaces for users or coaches, or the interfaces 104 generated by the pose monitoring platform 102 may serve as collaborative spaces through which users and coaches can communicate with one another.

As shown in FIG. 1, the pose monitoring platform 102 may reside in a network environment 100. Thus, the computing device on which the pose monitoring platform 102 is executing may be connected to one or more networks 106a-b. The networks 106a-b can include personal area networks (PANs), local area networks (LANs), wide area networks (WANs), metropolitan area networks (MANs), cellular networks, the Internet, etc. Additionally or alternatively, the computing device can be communicatively coupled to other computing devices over a short-range wireless connectivity technology, such as Bluetooth®, Near Field Communication (NFC), Wi-Fi® Direct (also referred to as “Wi-Fi P2P”), and the like. As an example, the pose monitoring platform 102 is embodied as a mobile application that is executable by a mobile phone or tablet computer in some embodiments. In such embodiments, the mobile phone or tablet computer may be communicatively connected to (i) one or more sensor units via a short-range wireless connectivity technology and (ii) a computer server via the Internet.

The interfaces 104 may be accessible via a web browser, desktop application, mobile application, or over-the-top (OTT) application. For example, a user may be able to access interfaces that are designed to guide her through a session in which predetermined physical activities (e.g., exercises) are to be performed a predetermined number of times via a mobile application that is executing on a mobile phone or tablet computer. As another example, a coach may be able to access interfaces through which she can review the progress of one or more users via a web browser executing on a tablet computer or laptop computer. As another example, a coach may be able to access interfaces through which she can personalize users' sessions based on, for example, their needs and progress. Accordingly, the interfaces 104 may be viewed on various computing devices depending on the nature of the pose monitoring platform 102 and its deployment. Examples of computing devices include desktop computers, laptop computers, tablet computers, mobile phones, wearable electronic devices (e.g., watches or fitness accessories), mobile workstations (also referred to as “computer carts”), network-connected electronic devices (e.g., televisions or home assistant devices), and virtual or augmented reality systems (e.g., head-mounted displays).

In some embodiments, at least some components of the pose monitoring platform 102 are hosted locally. That is, part of the pose monitoring platform 102 may reside on the computing device used to access one of the interfaces 104. For example, the pose monitoring platform 102 may be embodied as a mobile application executing on a mobile phone or tablet computer. In such embodiments, the instructions that, when executed, implement the pose monitoring platform 102 may reside largely or entirely on the mobile phone or tablet computer. Note, however, that the mobile application may be able to access a server system 108 on which other components of the pose monitoring platform 102 are hosted.

In other embodiments, the pose monitoring platform 102 is executed entirely by a cloud computing service operated by, for example, Amazon Web Services®, Google Cloud Platform™, or Microsoft Azure®. In such embodiments, the pose monitoring platform 102 may reside on a server system 108 comprised of one or more computer servers that are accessible via a network (e.g., the Internet). These computer servers can include information regarding different programs, sessions, or physical activities; computer-implemented models (or simply “models”) that indicate how anatomical regions should move when a given physical activity is performed; algorithms for processing data from which spatial position or orientation of anatomical regions can be computed, inferred, or otherwise determined; user data such as name, age, weight, ailment, enrolled program, duration of enrollment, number of sessions completed, and correspondence with coaches; and other assets.

Those skilled in the art will recognize that this information could also be distributed amongst a network-accessible server system and one or more computing devices. For example, some user data may be stored on, and processed by, her own computing device for security and privacy purposes. This information may be processed (e.g., encrypted or obfuscated) before being transmitted to the server system 108. As another example, some user data may be retrieved from an electronic health record (also referred to as an “electronic medical record”) that is maintained for the user. Electronic health records are normally maintained in storage that is managed by healthcare systems, and this storage may be accessible to the pose monitoring platform 102 (e.g., via an application programming interface). As another example, the algorithms and models needed to process the data from which the spatial position or orientation of anatomical regions of a given individual can be computed, inferred, or otherwise determined may be stored on, or accessible to, a computing device associated with the given individual to ensure that such data can be processed in real time (e.g., as physical activities are performed as part of a session). The data could be generated by one or more sensor units that are secured to the human body of the given individual (e.g., proximate to the anatomical regions), or the data could be generated by a camera that is included in, or accessible to, the computing device used by the given individual to initiate the session.

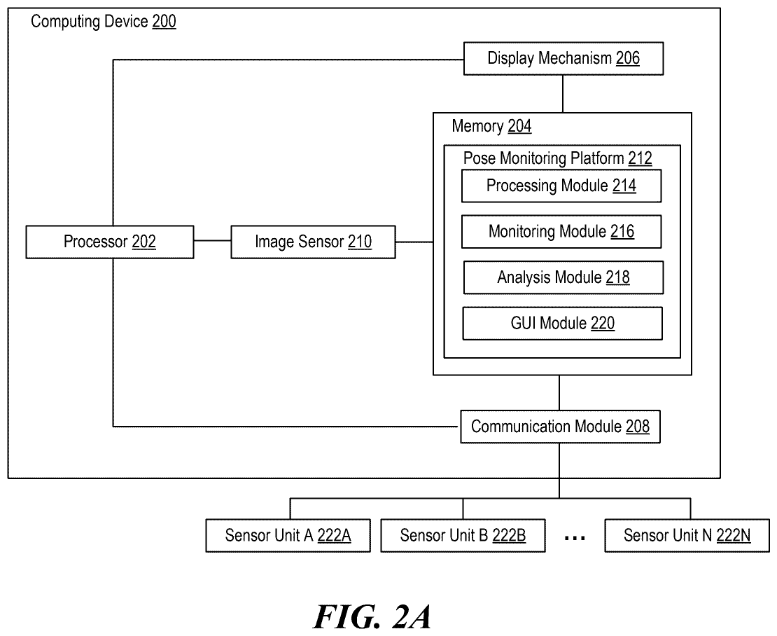

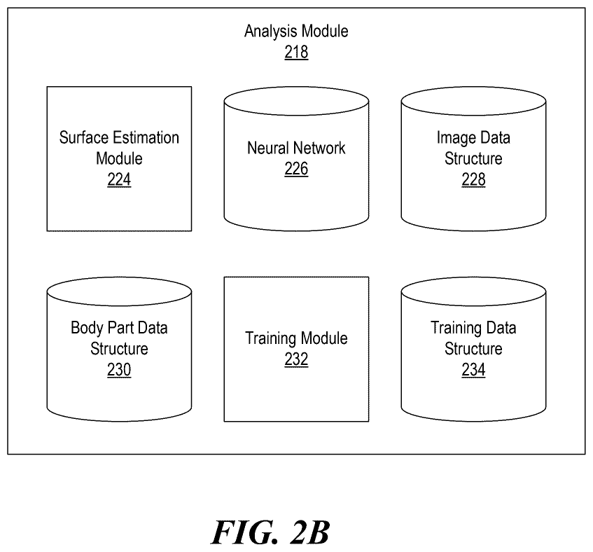

FIG. 2A illustrates an example of a computing device 200 that is able to implement a program in which a user is requested to perform physical activities, such as exercises, during sessions by a pose monitoring platform 212. In some embodiments, the pose monitoring platform 212 is embodied as a computer program that is executed by the computing device 200. In other embodiments, the pose monitoring platform 212 is embodied as a computer program that is executed by another computing device (e.g., a computer server) to which the computing device 200 is communicatively connected. In such embodiments, the computing device 200 may transmit data captured by the image sensor 210 to the other to the other computing device for processing. Those skilled in the art will recognize that aspects of the computer program could also be distributed amongst multiple computing devices.

The computing device 200 can include a processor 202, memory 204, display mechanism 206, communication module 208, and image sensor 210. Each of these components is discussed in greater detail below. Those skilled in the art will recognize that different combinations of these components may be present depending on the nature of the computing device 200.

The processor 202 can have generic characteristics similar to general-purpose processors, or the processor 202 may be an application-specific integrated circuit (ASIC) that provides control functions to the computing device 200. As shown in FIG. 2A, the processor 202 can be coupled to all components of the computing device 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the modules of the pose monitoring platform 212) and produced, retrieved, or obtained by the other components of the computing device 200. For example, data received by the communication module 208 from the image sensor 210 (via the processor 202) or sensor units 222A-N may be stored in the memory 204, or data produced by the image sensor 210 may be stored in the memory 204. Note that the memory 204 is merely an abstract representation of a storage environment. The memory 204 could be comprised of actual memory integrated circuits (also referred to as “chips”).

The display mechanism 206 can be any mechanism that is operable to visually convey information to a user (e.g., a user). For example, the display mechanism 206 may be a panel that includes light-emitting diodes (LEDs), organic LEDs, liquid crystal elements, or electrophoretic elements. In some embodiments, the display mechanism 206 is touch sensitive. Thus, a user may be able to provide input to the pose monitoring platform 212 by interacting with the display mechanism 206.

The communication module 208 may be responsible for managing communications between the components of the computing device, or the communication module 208 may be responsible for managing communications with other computing devices (e.g., sensor units 220A-N of FIG. 2A or server system 108 of FIG. 1). The communication module 208 may be wireless communication circuitry that is designed to establish communication channels with other computing devices. Examples of wireless communication circuitry include chips configured for Bluetooth, Wi-Fi, NFC, and the like. Assume, for example, that the computing device 200 is associated with a user. In such a scenario, the communication module 208 may initiate and then maintain a communication channel with a network-accessible server system managed by a digital service that is responsible for enrolling and then engaging users in programs. Moreover, the communication module 208 may initiate and then maintain communication channels with one or more external image sensors and/or one or more sensor units 222A-N that are secured to different anatomical regions of the user. As further discussed below, data generated by these components may be streamed to the pose monitoring platform 212 during a session for analysis.

The image sensor 210 may be any electronic sensor that is able to detect and convey information in order to generate images, generally in the form of image data or pixel data. Examples of image sensors include charge-coupled device (CCD) sensors and complementary metal-oxide semiconductor (CMOS) sensors. The image sensor 210 may be implemented in a camera that is implemented in the computing device 200. In some embodiments, the image sensor 210 is one of multiple image sensors implemented in the computing device 200. For example, the image sensor 210 could be included in a front- or rear-facing camera on a mobile phone. In some embodiments, the image sensor may be externally connected to the computing device 200 such that the image sensor 210 captures image data of an environment and sends the image data to the processing module 214.

For convenience, the pose monitoring platform 212 may be referred to as a computer program that resides within the memory 204. However, the pose monitoring platform 212 could be comprised of software, firmware, or hardware implemented in, or accessible to, the computing device 200. In accordance with embodiments described herein, the pose monitoring platform 212 may include a processing module 214, monitoring module 216, analysis module 218 and graphical user interface (GUI) module 220. These modules can be an integral part of the pose monitoring platform 212. Alternatively, these modules can be logically separate from the pose monitoring platform 212 but operate “alongside” it. Together, these modules may enable the pose monitoring platform 212 to guide a user through sessions that are performed as a part of a program designed to improve performance of one or more physical activities or manage/treat an MSK condition that is affecting a particular anatomical region.

The processing module 214 can process image data obtained from the image sensor 210 over the course of a session. The image data may be used to infer a spatial position or orientation of the corresponding anatomical region. For example, the processing module 214 may perform operations (e.g., filtering noise, changing contrast, reducing size) to ensure that the data can be handled by the other modules of the pose monitoring platform 212. As another example, the processing module 214 may temporally align the data with data obtained from another source (e.g., the sensor units 222A-N or another image sensor) if multiple data are to be used to establish the spatial position or orientation of the anatomical regions of interest.

In some embodiments, the processing module 214 additionally or alternatively processes data obtained from sensor units 222A-N attached to anatomical regions of the user over the course of the session. The processing module 214 can parse, filter or otherwise alter this data so that it is usable by the other modules of the pose monitoring platform 212. As an example, in some embodiments, the processing module 214 may examine this data in order to ensure that multiple streams of data received from different components (e.g., Sensor Unit A 222A and Sensor Unit B 222B) are temporally aligned with one another.

Moreover, the processing module 214 may be responsible for processing information input by users through interfaces generated by the GUI module 220. For example, the GUI module 220 may be configured to generate a series of interfaces that are presented in succession to a user as she completes physical activities as part of a session. On some or all of these interfaces, the user may be prompted to provide input. For example, the user may be requested to indicate (e.g., via a verbal command or tactile command provided via, for example, the display mechanism 206) that she is ready to proceed with the next physical activity, that she completed the last physical activity, that she would like to temporarily pause the session, etc. These inputs can be examined by the processing module 214 before information indicative of these inputs is forwarded to another module.

The monitoring module 216 can monitor ongoing movement of the user as she completes physical activities as part of a session. While the processing module 214 may be responsible for processing data streamed to the pose monitoring platform 212 (e.g., by the image sensor 210 or, in some embodiments, the sensor units 222A-N), the monitoring module 216 may be responsible for determining whether the user is moving as would be expected when completing a physical activity. As an example, assume that the imager sensor 210 is positioned in front of a user. During a session, the user may be instructed to perform an exercise such as a side plank in which the hips are lifted away from the ground. In such a scenario, the monitoring module 216 can examine image data generated by the image sensor 210 to determine whether the thorax and lumbar regions of the user's body are moving—either in terms of three-dimensional (3D) space or with respect to one another—as would be expected given the exercise.

The analysis module 218 may be responsible for determining adherence to individual physical activities, sets of physical activities performed during sessions, or sets of sessions performed as part of a program.

FIG. 2B illustrates an analysis module 218 of the pose monitoring platform of FIG. 2A, where the analysis module is structured to facilitate 3D surface estimation with correction for perspective. As shown in FIG. 2B, the analysis module 218 includes a surface estimation module 224, a neural network 226, an image data structure 228, a body part data structure 230 a training module 232, and a training data structure 234. In some embodiments, the analysis module 218 may include a subset of the modules and data structures shown in FIG. 2B, or the analysis module 218 may include additional modules or data structures that are not shown in FIG. 2B.

The surface estimation module 224 may be responsible for determining estimated poses of body parts as users perform physical activities. Body parts may include any portion of a user's body used to perform a physical activity (e.g., hands, feet, torso, etc.). A body part may refer to a single anatomical region (e.g., a hand), one anatomical region in relation to another anatomical region (e.g., a hand in relation to an elbow), or a series of anatomical regions in relation to another anatomical region (e.g., fingers of a hand). Physical activities may include movements performed for wellness, sports, dance, virtual reality experiences, augmented reality experiences, physical therapy, or any other activity that requires physical movement. Some examples of physical activities include dance moves (e.g., pliés, moonwalks, shuffles, etc.), sporting techniques (e.g., football throws, soccer kicks, tennis serves, basketball layups, yoga poses, etc.), exercises (e.g., planks, hip extensions, etc.), stretches, posture techniques (e.g., standing/sitting at desk for healthy back and neck), and cooking techniques (e.g., chopping, kneading, dicing, etc.).

The surface estimation module 224 can obtain image data of an environment from the image sensor 210. The environment includes a user as she is performing one or more physical activities. In some embodiments, the image data may depict the user's entire body in the environment. In other embodiments, the image data may depict one or more of the user's body parts in the environment. For example, in one embodiment, the image data may only depict the hands and feet of the user. In some embodiments, the image data may depict body parts of multiple users. The surface estimation module 224 may store the image data in the image data structure 228 along with an indication of a time, date, or location associated with the capture of the image data.

In some embodiments, the image data structure 228 may be implemented on a computing device 200 where the image sensor 210 is located. In other embodiments, the image data structure 228 may be implemented in the server system of FIG. 1. The image data structure may be formatted to expedite pose analysis by the analysis module 218. For example, in some instances, the image data structure 228 may be tabulated by identifiers associated with the particular image sensor 210 that capture the image data, identifiers of the users depicted in or otherwise associated with the image data, and/or identifiers of a computing device 200 that transmitted the image data to the analysis module 218.

The surface estimation module 224 can extract one or more feature maps from the image data. In one embodiment, the surface estimation module 224 segments the image data into contiguous regions of pixels. Each contiguous region of pixels may be associated with a portion of the environment. In some embodiments, the surface estimation module 224 segments the image data based on objects shown in the image data. For example, the surface estimation module 224 may extract pixels representing the floor into a first region, a piece of furniture into a second region, a user's right hand into a third region. In another embodiment, the body pose module segments the image data based on contrast between colors of and/or distance between the pixels. The body pose module may use one or more machine learned models to segment the image data or may use an algorithm. For example, pixels representing a hand may have similar coloring and be within a set distance threshold of one another compared to pixels of a green wall behind the hand. The surface estimation module 224 may create groups of pixels each associated with a color range (e.g., light to dark green or dark yellow to light orange). For each group, the surface estimation module 224 may determine a weighted average location of the pixels and remove pixels from the group that are a threshold distance away from the weighted average location. The surface estimation module 224 may iterate upon this grouping process until every pixel is associated with a group (e.g., a segment of the image data).

The surface estimation module 224 extracts a feature map for each segment of the image data. The term “feature map” may be used to refer to a vectorial representation of features in the image data. The surface estimation module 224 may extract feature maps by applying filters or feature detectors to each segment. For example, the surface estimation module 224 may apply a filter that detects skin to a segment and may receive, as output, a feature map highlighting which portions of the segment include skin. The surface estimation module 224 may store the segments and associated feature maps in the image data structure 228 or another datastore.

The surface estimation module 224 can apply the neural network 226 to each extracted feature map. The neural network 226 may include a series of convolutional layers and a series of connected layers of decreasing size and the last layer of the neural network 226 may be a sigmoid activation function. The neural network 226 can include a plurality of parallel branches that are configured to together estimate poses of body parts based on the feature maps. A first branch of the neural network 226 could be configured to determine a likelihood that the portion of the environment associated with the segment includes a body part, while a second branch of the neural network 226 could be configured to determine an estimated pose of the body part in the portion of the environment associated with the segment. In some embodiments, the surface estimation module 224 may employ an additional or alternative machine-learning or artificial intelligence framework to the neural network 226 to estimate poses of body parts.

In some embodiments, the neural network 226 may include additional or alternative branches that the surface estimation module 224 employs together to determine a pose of a body part. For example, in some embodiments, the neural network 226 includes a set of branches for each possible body part that may be included in the segment. For example, the neural network 226 may include a set of hand branches that determine a likelihood that the segment includes a hand and estimated poses of hands in the segment. The neural network may similarly include a set of branches that detect right legs in the segment and determine poses of the right legs in the segment and another set of branches that detects and determines poses of left legs in the segment. Further, the neural network 226 may include branches for other anatomical regions (e.g., elbows, fingers, neck, torso, upper body, hip to toes, chest and above, etc.) and/or sides of a user's body (e.g., left, right, front, back, top, bottom). The neural network is further described below in relation to the training module 232.

The surface estimation module 224 can compare the likelihood determined by the first branch of the neural network to a threshold value. The higher the likelihood, the more likely the feature map includes a body part associated with the first branch of the neural network. In some embodiments, if the surface estimation module 224 determines that the likelihood is greater than the threshold value, the surface estimation module 224 stores an indication in the body part data structure 230 that the body part in the segment is in the estimated pose determined by the second branch of the neural network 226. In embodiments where the neural network 226 includes a set of branches, each corresponding to a different body part (e.g., such as each body part of the body or a subset of body parts related to a specific portion of the body, such as the torso, lower body, etc.), the surface estimation module 224 compares the likelihood determined by the set to a threshold related to the body part of the set. If the likelihood exceeds the threshold, the surface estimation module 224 stores an indication in the body part data structure 230 that the body part in the segment is in the estimated pose determined by the set. In some embodiments, the surface estimation module 224 stores the indication with the time, date, and or location associated with the image data of the segment.

In some embodiments, for each indication, the surface estimation module 224 may cause the display mechanism 206 to display an indication that the user is performing the estimated pose with the body part. The surface estimation module 224 may do so in near real time. For example, the surface estimation module 224 may receive and segment image data and apply the neural network 226 to determine a pose of a body part as the user is performing the pose in real time. After performing such processing, the surface estimation module 224 may cause the display mechanism 206 to display the indication, allowing the user to move her body parts if she is aiming for a different pose. In some embodiments, the surface estimation module 224 may send indications to the GUI module 220 for display via the display mechanism 206, rather than directly causing the display mechanism 206 to display indications or other information.

In some embodiments, for each indication, the surface estimation module 224 determines one or more physical activities associated with estimated pose. For instance, the surface estimation module 224 may access physical activities related to poses in the body part data structure 230. For example, the pose “left-handed fist” may be associated with the physical activities “kickboxing jab,” “volleyball serve,” “hand therapy fist,” and “cooking utensil hold.” The surface estimation module 224 may access user data associated with the user (e.g., stored in memory of the pose monitoring platform 102 or accessed via a network by the pose monitoring platform 102). The surface estimation module 224 can select a physical activity from among the physical activities associated with the pose based on the user's data. For example, if the user's data indicates that she is undergoing therapy for her hand, the surface estimation module 224 may select the physical activity “hand therapy fist.” The surface estimation module 224 may cause the display mechanism 206 to display an indication of the physical activity to the user. In further embodiments, the surface estimation module 224 may access instructions for how the user could improve her technique (e.g., to achieve a therapeutic goal) for the physical activity based on the pose from the body part data structure 230 and cause the display mechanism 206 to display the instructions to the user. For example, if the surface estimation module 224 determines that, while kickboxing, the user is posing her hand in a fist with her thumb enclosed by her fingers, the surface estimation module 224 may cause the display mechanism 206 to display instructions for the user move her thumb to rest on the outside of her fingers.

In some embodiments, the surface estimation module 224 can determine whether a physical activity was successfully completed by the user based on estimated body poses. For example, if an estimated body pose does not match the physical activity that a user is supposed to be doing (e.g., determined based on user data), then the surface estimation module 224 may prevent further progression through a session hosted by the pose monitoring platform 102 until the physical activity is determined to have been performed with one or more certain poses. In another example, the surface estimation module 224 may update the session based on the estimated body pose to further teach the user how to perform the body pose if the user has not matched a pattern representative of a first athletic activity. The body pose module may also update the session to focus on a second activity upon to determining that the body pose does match the pattern.

The training module 232 can train a first branch (or a first set of branches that determine likelihoods, in some embodiments) of the neural network 226 to determine whether image data contains body parts. The training module 232 may obtain a set of digital images from the pose monitoring platform 102 or from a computing device connected to the pose monitoring platform 102. The training module 232 can determine, based on locations in the set of digital images, spatial positions of one or more body parts in each of the set of digital images. In one embodiment, the training module 232 may use an object detection model (also called an “object detector”), object recognition model (also called an “object recognizer”), or another computer vision technique to determine spatial positions of body parts. For each body part detected in the set of images, the training module 232 can place a bounding box around the body part in each image. The training module 232 can then iteratively displace the bounding box within the image until the bounding box no longer surrounds spatial positions associated with the body part. For each displaced instance of the bounding box, the training module 232 can add the portion of the image associated with (e.g., enclosed by) the bounding box, to a first set of training data stored in the training data structure 234. The training module 232 can then train the first branch (or the first set of branches) on the first set of training data.

In some embodiments, the training module 232 causes a display mechanism 206 of a computing device 200 associated with an external operator to display each digital image in the set. The training module 232 may receive interactions made by the operator via a GUI of the display mechanism 206, where one or more of the interactions indicate placement of bounding boxes around body parts in the digital images and includes labels for the bounding boxes with poses of an included body part. The training module 232 can add the portion of the image associated with each bounding box to a second set of training data in the training data structure 234. The training module 232 can then train the second branch of the neural network 226 on the second set of training data. In embodiments where the neural network includes a set of branches for each body part, the training module 232 can train the branches configured to estimate a pose of the body part on the second set of training data.

The training module 232 trains the neural network on the training data. In some embodiments, the training module 232 may retrain the neural network 226 each time new images are added to the training data. In other embodiments, the training module 323 may retrain the neural network 226 in response to a determination that at least a predetermined number of new images have been added to the training data. In further embodiments, the training module 232 may separate the training data based on the body part shown in each bounding box and train branches of the neural network 226 on training data corresponding to a particular body part (e.g., the branch trained for recognizing the pose of a foot is trained on images of feet).

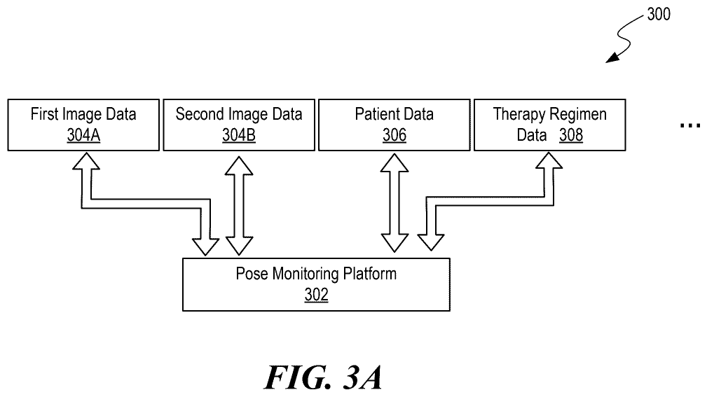

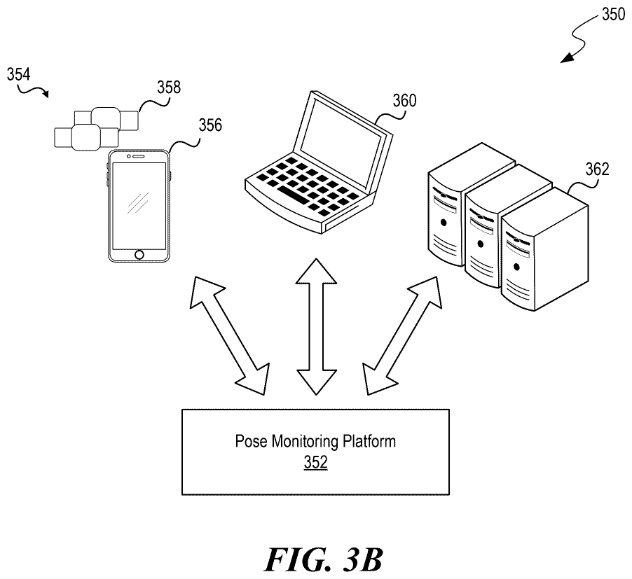

FIG. 3A depicts an example of a communication environment 300 that includes a pose monitoring platform 302 configured to receive several types of data, where the data can be used to facilitate 3D surface estimation with correction for perspective. Here, for example, the pose monitoring platform 302 receives first image data 304A that captured by a first image sensor (e.g., image sensor 210 of FIG. 2A) located in front of a user, second image data 304B generated by a second image sensor located behind a user, user data 306 that is representative of information regarding the user, and therapy regimen data 308 that is representative of information regarding the program in which the user is enrolled. Those skilled in the art will recognize that these types of data have been selected for the purpose of illustration. Other types of data, such as community data (e.g., information regarding adherence of cohorts of users), could also be obtained by the pose monitoring platform 302.

These data may be obtained from multiple sources. For example, the therapy regimen data 308 may be obtained from a network-accessible server system managed by a digital service that is responsible for enrolling and then engaging users in programs. The digital service may be responsible for defining the series of physical activities to be performed during sessions based on input provided by coaches. As another example, the user data 306 may be obtained from various computing devices. For instance, some user data 306 may be obtained directly from users (e.g., who input such data during a registration procedure or during a session), while other user data 306 may be obtained from employers (e.g., who are promoting or facilitating a wellness program) or healthcare facilities such as hospitals and clinics. Additionally or alternatively, user data 306 could be obtained from another computer program that is executing on, or accessible to, the computing device on which the pose monitoring platform 302 resides. For example, the pose monitoring platform 302 may retrieve user data 306 from a computer program that is associated with a healthcare system through which the user receives treatment. As another example, the pose monitoring platform 302 may retrieve user data 306 from a computer program that establishes, tracks, or monitors the health of the user (e.g., by measuring steps taken, calories consumed, or heart rate).

FIG. 3B depicts another example of a communication environment 350 that includes a pose monitoring platform 352 configured to obtain data from one or more sources, where the data can be used to facilitate 3D surface estimation with correction for perspective. Here, the pose monitoring platform 352 may obtain data from a therapy system 354 comprised of a tablet computer 356 and one or more sensor units 358 (e.g., image sensors), personal computer 360, or network-accessible server system 362 (collectively referred to as the “networked devices”). For example, the pose monitoring platform 352 may obtain data regarding movement of a user during a session from the therapy system 354 and other data (e.g., therapy regimen information, models of exercise-induced movements, feedback from coaches, and processing operations) from the personal computer 360 or network-accessible server system 362.

The networked devices can be connected to the pose monitoring platform 352 via one or more networks. These networks can include PANs, LANs, WANs, MANs, cellular networks, the Internet, etc. Additionally or alternatively, the networked devices may communicate with one another over a short-range wireless connectivity technology. For example, if the pose monitoring platform 352 resides on the tablet computer 356, data may be obtained from the sensor units over a Bluetooth communication channel, while data may be obtained from the network-accessible server system 362 over the Internet via a Wi-Fi communication channel.

Embodiments of the communication environment 350 may include a subset of the networked devices. For example, some embodiments of the communication environment 350 include a pose monitoring platform 352 that obtains data from the therapy system 354 (and, more specifically, from the sensor units 358) in real time as physical activities as performed during a session and additional data from the network-accessible server system. This additional data may be obtained periodically (e.g., on a daily or weekly basis, or when a session is initiated).

### Facilitating Human 3D Surface Estimation With Correction for Perspective

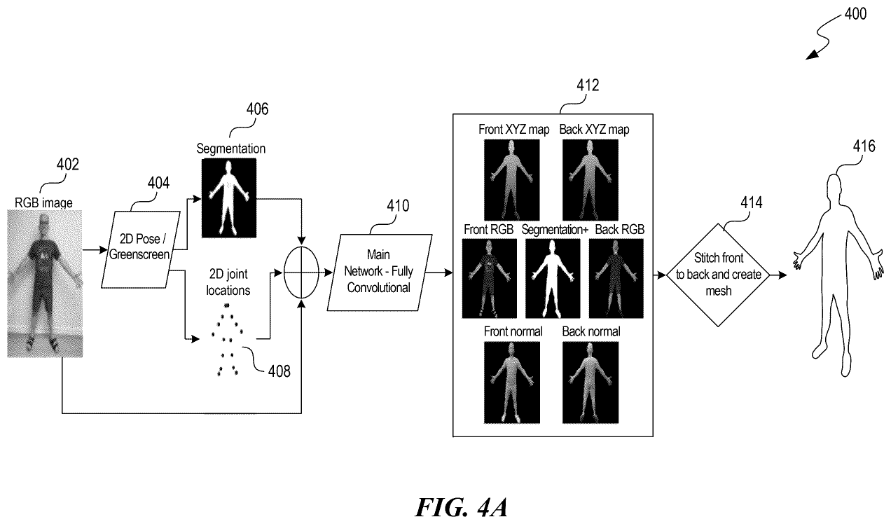

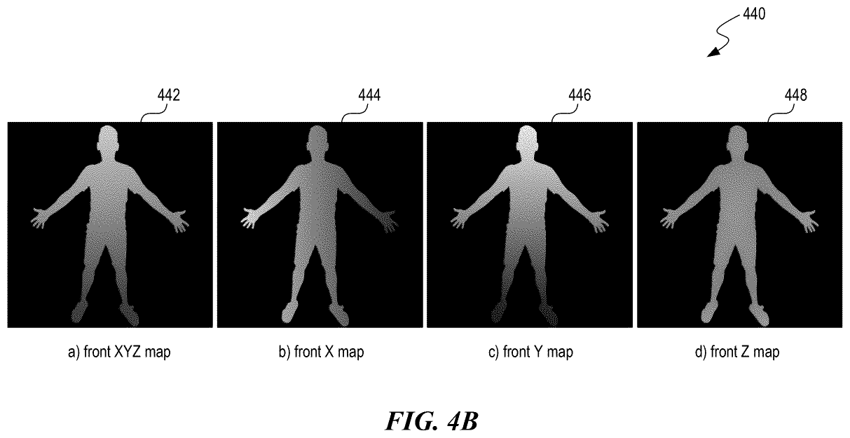

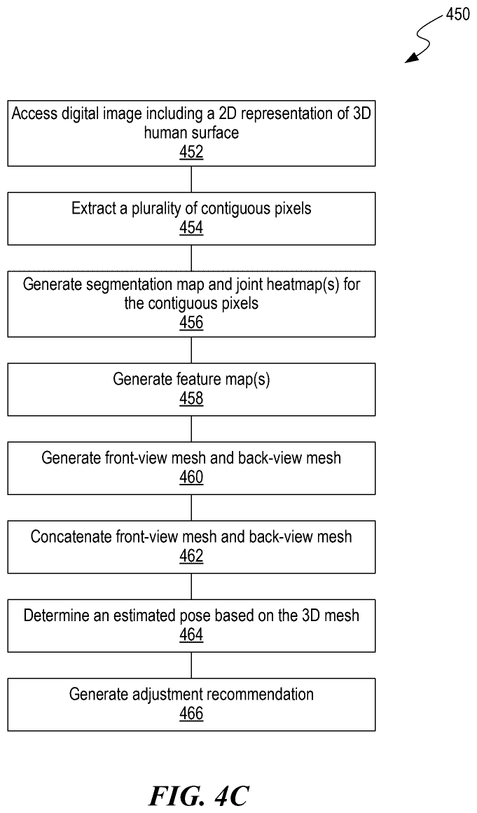

FIG. 4A depicts a block diagram of a process for facilitating human 3D surface estimation with correction for perspective in a pose monitoring platform. As shown, a digital image 402 is initially acquired or generated by a pose monitoring platform (e.g., pose monitoring platform 102 of FIG. 1, pose monitoring platform 212 of FIG. 2, or pose monitoring platforms 302, 352 of FIGS. 3A-B). In some embodiments, the pose monitoring platform is representative of, or embodied in the form of, a computer program, circuit, and/or similar provided to a computing device. The computing device can include or be communicatively coupled to a camera, which can be caused by the computer program or by other software (e.g., the operating system) or other hardware implemented on the computing device to take a picture of a user and generate the digital image 402. In some embodiments, the digital image 402 is a previously captured image that is retrievably stored on a data storage media associated with, or accessible to, the pose monitoring platform. For example, when a user signs into a corresponding digital account through an interface generated by the pose monitoring platform, the pose monitoring platform can access and retrieve a previously stored digital image 402 associated with the logged-in user (e.g., by determining the logged-in user's login credentials and cross-referencing the determined credentials against the retrievably stored data). In some embodiments, the digital image 402 is extracted from a previously stored video file. In some embodiments, digital image 402 is extracted from a live and/or buffered video stream received in substantially real time from the computing device (e.g., when monitoring a user's performance of a particular exercise).

In some embodiments, the digital image 402 is a color image. For example, the digital image 402 can conform to an additive color model, such as a red-green-blue (RGB) color model. More generally, the digital image 402 can conform to any model suitable for sensing, representation, and display of images in electronic systems.

The digital image 402 can include a 2D representation 404 of a particular user. In some embodiments, the pose monitoring platform can use a suitable object recognition technique to extract from the digital image 402 a collection of pixels that represent the user. In some embodiments, extracting the 2D representation 404 involves applying a machine learning model to differentiate between an image of a person and background imagery. In some embodiments, extracting the 2D representation 404 includes generating and displaying on the computing device a user interface that allows a user to apply and/or correct (e.g., move, refine) an outline of the automatically determined 2D representation, such as a bounding box.

Based on the 2D representation 404, the pose monitoring platform can generate a coarse segmentation mask 406 and/or a joint map 408. In some embodiments, a neural network-based technique and/or platform, such as wrnchAI and/or MaskRCNN, can be used to generate the coarse segmentation mask 406 and/or a joint map 408. The coarse segmentation mask 406 identifies groups of pixels in the 2D representation 404 that represent (e.g., fall within the outline of) a body part. The joint map 408 identifies relative predicted locations of one or more joints in a body area included in the 2D representation 404. In some embodiments, the joint map 408 can be generated by cross-referencing a retrievably stored digital model of a particular body part. In some embodiments, the joint map 408 can be generated and/or augmented by using a suitable object recognition technique on the digital image 402. In some embodiments, these approaches can be used in an additive fashion to refine a particular joint map 408. For example, an initial joint map 408 can include points estimated using cross-reference data. The joint map 408 can be refined using object recognition techniques to identify joint locations with a greater degree of accuracy. According to various embodiments, a suitable number of joints (e.g., up to sixteen (16) in one example implementation) can be determined.

The output(s) of the above-described operations are passed to a convolutional neural network 410 trained to estimate human 3D surface(s) with correction for perspective. According to various embodiments, the neural network 410 can be trained on labeled or otherwise classified images of various body parts and using supplemental data, such as output from cameras with a variety of field-of-view settings, resolution settings, picture size settings, and/or other attributes. In some embodiments, the neural network 410 is trained on a plurality of images generated using the same camera and settings and cropped to various degrees. Training on various camera parameters, settings and crop levels improves the precision of the convolutional neural network 410, as cameras may distort different parts of an image to various degrees (e.g., portions of an image closer to the edges may be distorted to a greater degree).

In an example embodiment, the neural network 410 is structured to receive a segmented digital image 402. For example, the pose monitoring platform can generate X-, Y-, and Z-coordinate maps and feed these to the neural network 410 as values assigned to each of three corresponding channels, where each channel represents a particular attribute, dimension and/or property of the estimated 3D human surface. Other input channels in the neural network 410 can receive segmentation map(s), joint heatmaps, etc.

The neural network 410 operates on the input data to generate a set of outputs 412. In some embodiments, the outputs 412 can include a refined (Segmentation⁺) map that shows a refined segmentation of the body part shown in the digital image 402. The Segmentation+map can be stored and/or displayed in association with various predicted properties for the pixels included in the Segmentation⁺ map. In an example embodiment, these properties, which are predicted by the neural network, can include a plurality of front X, Y, Z locations, which can be represented as three respective maps, also shown in FIG. 4B, each showing a predicted coordinate (X, Y, or Z) location of the closest point of each pixel, with respect to the camera viewfinder, in meters. The properties can further include a plurality of thickness X, Y, Z locations, which can be represented as three respective maps, each showing a predicted coordinate (X, Y, or Z) location of the furthest point of each pixel, with respect to the camera viewfinder, in meters. The properties can further include a plurality of front RGB values, which can be represented as three respective maps, each showing determined or predicted base color of the front surface of a projected 3D representation of a pixel. The properties can further include a plurality of back RGB values, which can be represented as three respective maps, each showing determined or predicted base color of the back surface of a projected 3D representation of a pixel. The properties can further include a plurality of projected front pixel surface normal values and/or back pixel surface normal values for a projected 3D representation of a pixel.

The outputs 412 can be used to generate a 3D mesh 414, which is an approximation of the 3D human surface 416. To generate the 3D mesh 414, the 3D location of the front surface point of pixel [i, j] can be represented as a set of feature maps {FrontX(i, j), FrontY(i, j), FrontZ(i, j)}. The 3D location of the back surface point of pixel [i, j] can be represented as a set of feature maps {BackX(i, j), BackY(i, j), BackZ(i, j)}. The base color of the front surface point of pixel [i, j] can be represented as FrontRGB(i, j). The base color of the back surface point of pixel [i, j] can be represented as BackRGB(i, j). Together, these representations define parameters for generating and displaying, via a user interface, the predicted 3D human surface 416.

FIG. 4B depicts X-, Y-, and Z-coordinate dimensional maps used in human 3D surface estimation with correction for perspective in a pose monitoring platform. In some embodiments, the X-, Y-, and Z-coordinate dimensional maps (444, 446, and 448, respectively) can be used to generate the front XYZ map 442. Each map shows a predicted coordinate (X, Y, or Z) location of the closest point of each pixel, with respect to the camera viewfinder, in meters.

The resulting generated XYZ map 442 can be used to generate the front mesh (a mesh representation of the front surface of the body part or human surface). A similar set of maps can be used to generate a back mesh. The front mesh and the back mesh can be stitched together to generate a prediction of the 3D human surface. Advantageously, in addition to using the Z-coordinate dimensional map 448, X- and Y-coordinate dimensional maps 444 and 446 are used to predict horizontal and vertical offsets for the corresponding pixels. The predicted offset values can be used to minimize distortion.

FIG. 4C depicts a flow diagram of a process for facilitating human 3D surface estimation with correction for perspective in a pose monitoring platform. The process can include computer-based operations performed by a suitable module and/or computing device of the pose monitoring platform (e.g., pose monitoring platform 102 of FIG. 1, pose monitoring platform 212 of FIG. 2, or pose monitoring platforms 302, 352 of FIGS. 3A-B), such as the surface estimation module 224 of FIG. 2A.

At 452, the surface estimation module 224 can access and/or generate a digital image that includes a 2D representation of a 3D human surface. In some embodiments, accessing the digital image includes causing a camera operably coupled to the computing device to capture the digital image. In some embodiments, accessing the digital image includes causing a computer program executing on the computing device to generate the digital image by cropping a source image. In some embodiments, accessing the digital image includes receiving the digital image from a source external to the computing device via a communication channel. In some embodiments, accessing the digital image includes retrieving the digital image from a storage media accessible to the computing device.

At 454, the surface estimation module 224 can extract a plurality of contiguous pixels from the digital image using a suitable object recognition technique and/or by applying and prompting a user to correct a bounding box around a portion of the digital image. The plurality of contiguous pixels correspond to the 2D representation of the human 3D surface. For example, the plurality of contiguous pixels can include an outline of the human body or a body part.

At 456, the surface estimation module 224 can generate a segmentation map and/or joint map(s) for the contiguous pixels as described, for example, in reference to FIG. 4A. In some embodiments, the joint map(s) are heatmaps. In some embodiments, the segmentation map and/or joint map(s) are generated by a particular branch of a neural network.

At 458, the surface estimation module 224 can generate, by a different branch of the neural network or by a second neural network different from the neural network at 458, a plurality of feature maps corresponding to the extracted contiguous pixels in the segmentation map. Each of the plurality of feature maps can be an approximation of a parameter descriptive of the human 3D surface. The parameters can include, for example, a front spatial location, a back spatial location, a thickness, a base color, and a surface normal.

At 460, the surface estimation module 224 can generate a front 3D mesh and a back 3D mesh that approximates the human 3D surface based on the feature maps. These operations can include, based on a first subset of the plurality of feature maps that include front-view related parameters, generating a front-view mesh that approximates a first aspect of the human 3D surface. The operations can further include, based on a second subset of the plurality of feature maps that include back-view related parameters, generating a back-view mesh that approximates a second aspect of the human 3D surface. In some embodiments, the neural network is trained in separate iterations to generate the front and back 3D meshes using different sets of attributes, which may overlap only in part.

At 462, the surface estimation module 224 can concatenate the front-view mesh and the back-view mesh to generate a 3D mesh. The 3D mesh represents a three-dimensional outline (including depth) predicted to correspond to the 3D human image.

At 464, the surface estimation module 224 can predict a pose corresponding to the generated 3D mesh. In some embodiments, the surface estimation module 224 can cross-reference retrievably stored data regarding poses. In some embodiments, the surface estimation module 224 can select a subset of data corresponding two or more poses and further narrow down the set based on an inferred secondary attribute determined by analyzing properties (e.g., angles, curvature) of the 3D human surface represented by the generated 3D mesh and comparing the properties to anticipated value ranges for each of the poses in the subset to select the predicted pose.

At 466, the surface estimation module 224 can generate a visual indicium with instructions on how to adjust the determined pose. In some embodiments, the visual indicium includes a graphic (e.g., an avatar that mimics movement of the human or illustrates how the human should move). In some embodiments, the visual indicium includes a textual prompt (e.g., “Straighten back while bending over.”)

### Processing System

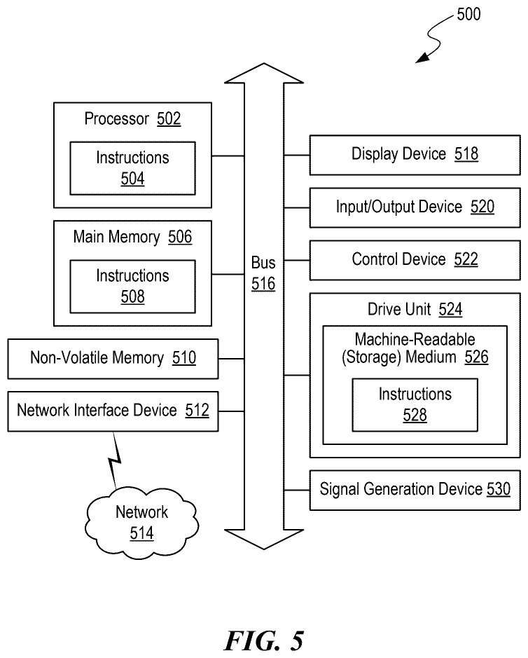

FIG. 5 is a block diagram illustrating an example of a processing system 500 in which at least some operations described herein can be implemented. For example, components of the processing system 500 may be hosted on a computing device that includes a pose monitoring platform (e.g., pose monitoring platform 102 of FIG. 1, pose monitoring platform 212 of FIG. 2, or pose monitoring platforms 302, 352 of FIGS. 3A-B).

The processing system 500 may include a processor 502, main memory 506, non-volatile memory 510, network adapter 512, video display 518, input/output device 520, control device 522 (e.g., a keyboard or pointing device), drive unit 524 including a storage medium 526, and signal generation device 530 that are communicatively connected to a bus 516. The bus 516 is illustrated as an abstraction that represents one or more physical buses or point-to-point connections that are connected by appropriate bridges, adapters, or controllers. The bus 516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 506, non-volatile memory 510, and storage medium 526 are shown to be a single medium, the terms “machine-readable medium” and “storage medium” should be taken to include a single medium or multiple media (e.g., a centralized/distributed database and/or associated caches and servers) that store one or more sets of instructions 528. The terms “machine-readable medium” and “storage medium” shall also be taken to include any medium that is capable of storing, encoding, or carrying a set of instructions for execution by the processing system 500.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in a computing device. When read and executed by the processors 502, the instruction(s) cause the processing system 500 to perform operations to execute elements involving the various aspects of the present disclosure.

Further examples of machine-and computer-readable media include recordable-type media, such as volatile memory devices and non-volatile memory devices 510, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 512 enables the processing system 500 to mediate data in a network 514 with an entity that is external to the processing system 500 through any communication protocol supported by the processing system 500 and the external entity. The network adapter 512 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method for estimating human three-dimensional (3D) surface with correction for perspective, the method comprising:
accessing a digital image comprising a two-dimensional (2D) representation of the human 3D surface;
extracting, from the digital image, a plurality of contiguous pixels corresponding to the 2D representation of the human 3D surface; and
performing, at least in part by a neural network, operations on the plurality of the extracted contiguous pixels, the operations comprising:
generating, by a first branch of the neural network, (i) a segmentation map that includes the extracted contiguous pixels and (ii) a plurality of joint heatmaps corresponding to the 2D representation of the human 3D surface, and
based on the extracted contiguous pixels and the plurality of joint heatmaps,
generating, by a second branch of the neural network, a plurality of feature maps and corresponding to the extracted contiguous pixels in the segmentation map, wherein each of the plurality of feature maps is an approximation of a parameter descriptive of the human 3D surface, wherein the plurality of feature maps include at least an X-map approximating an X-coordinate offset and a Y-map approximating a Y-coordinate offset for an item represented by a pixel, and
based on the plurality of feature maps, generating a 3D mesh that approximates the human 3D surface.

2. The method of claim 1, wherein a parameter descriptive of the human 3D surface is approximated by a characteristic of at least one pixel of the extracted contiguous pixels, the parameter being one of: a front spatial location, a back spatial location, a thickness, a base color, and a surface normal.

3. The method of claim 1, wherein generating the 3D mesh comprises:
based on a first subset of the plurality of feature maps, generating a front-view mesh that approximates a first aspect of the human 3D surface;
based on a second subset of the plurality of feature maps, generating a back-view mesh that approximates a second aspect of the human 3D surface; and
generating the 3D mesh by concatenating the front-view mesh and the back-view mesh.

4. The method of claim 3, wherein the second branch of the neural network is trained, in a first training iteration, to generate the front-view mesh and, in a separate second training iteration, to generate the back-view mesh.

5. The method of claim 1, wherein the second branch of the neural network is trained on a plurality of digital images in a training set, each digital image in the training set corresponding to a particular parameter of a camera used to generate the plurality of digital images.

6. The method of claim 1, wherein the method is performed upon execution of computer-executable code on a computing device, and wherein accessing the digital image comprises at least one of:
causing a camera operably coupled to the computing device to capture the digital image,
causing a computer program executing on the computing device to generate the digital image by cropping a source image,
receiving the digital image from a source external to the computing device via a communication channel, or
retrieving the digital image from a storage media accessible to the computing device.

7. The method of claim 1, further comprising:
determining, based on the 3D mesh, an estimated pose associated with the human 3D surface.

8. The method of claim 7, further comprising:
generating an adjustment recommendation based on the estimated pose.

9. The method of claim 8, further comprising:
providing, via an output device, a prompt that includes a visual indicium of the adjustment recommendation.

10. One or more non-transitory computer-readable storage media having computer-executable instructions for estimating human three-dimensional (3D) surface with correction for perspective stored thereon, the instructions, when executed by at least one processor, causing a computing device to perform operations comprising:
accessing a digital image comprising a two-dimensional (2D) representation of the human 3D surface;
extracting, from the digital image, a plurality of contiguous pixels corresponding to the 2D representation of the human 3D surface; and
performing, at least in part by a neural network, operations on the plurality of the extracted contiguous pixels, the operations comprising:
generating, by a first branch of the neural network, (i) a segmentation map that includes the extracted contiguous pixels and (ii) a plurality of joint heatmaps corresponding to the 2D representation of the human 3D surface, and
based on the extracted contiguous pixels and the plurality of joint heatmaps,
generating, by a second branch of the neural network, a plurality of feature maps and corresponding to the extracted contiguous pixels in the segmentation map, wherein each of the plurality of feature maps is an approximation of a parameter descriptive of the human 3D surface, wherein the plurality of feature maps include at least an X-map approximating an X-coordinate offset and a Y-map approximating a Y-coordinate offset for an item represented by a pixel, and
based on the plurality of feature maps, generating a 3D mesh that approximates the human 3D surface.

11. The media of claim 10, wherein a parameter descriptive of the human 3D surface is approximated by a characteristic of at least one pixel of the extracted contiguous pixels, the parameter being one of: a front spatial location, a back spatial location, a thickness, a base color, and a surface normal.

12. The media of claim 10, wherein generating the 3D mesh comprises:
based on a first subset of the plurality of feature maps, generating a front-view mesh that approximates a first aspect of the human 3D surface;
based on a second subset of the plurality of feature maps, generating a back-view mesh that approximates a second aspect of the human 3D surface; and
generating the 3D mesh by concatenating the front-view mesh and the back-view mesh.

13. The media of claim 12, wherein the second branch of the neural network is trained, in a first training iteration, to generate the front-view mesh and, in a separate second training iteration, to generate the back-view mesh.

14. The media of claim 10, wherein the second branch of the neural network is trained on a plurality of digital images in a training set, each digital image in the training set corresponding to a particular parameter of a camera used to generate the plurality of digital images.

15. The media of claim 10, wherein accessing the digital image comprises at least one of:
causing a camera operably coupled to a computing device to capture the digital image,
causing a computer program executing on the computing device to generate the digital image by cropping a source image,
receiving the digital image from a source external to the computing device via a communication channel, or
retrieving the digital image from a storage media accessible to the computing device.

16. The media of claim 10, the instructions further comprising:
determining, based on the 3D mesh, an estimated pose associated with the human 3D surface.

17. The media of claim 16, the instructions further comprising:
generating an adjustment recommendation based on the estimated pose.

18. The media of claim 17, the instructions further comprising:
providing, via an output device, a prompt that includes a visual indicium of the adjustment recommendation.

19. A computing system comprising at least one processor, at least one memory, and computer-executable instructions stored in the at least one memory that, when executed by the at least one processor, cause the at least one processor to perform operations for estimating human three-dimensional (3D) surface with correction for perspective, the operations comprising:
access a digital image comprising a two-dimensional (2D) representation of the human 3D surface;
extract, from the digital image, a plurality of contiguous pixels corresponding to the 2D representation of the human 3D surface; and
perform, at least in part by a neural network, operations on the plurality of the extracted contiguous pixels, the operations comprising:
generate, by a first branch of the neural network, (i) a segmentation map that includes the extracted contiguous pixels and (ii) a plurality of joint heatmaps corresponding to the 2D representation of the human 3D surface, and
based on the extracted contiguous pixels and the plurality of joint heatmaps,
generate, by a second branch of the neural network, a plurality of feature maps and corresponding to the extracted contiguous pixels in the segmentation map, wherein each of the plurality of feature maps is an approximation of a parameter descriptive of the human 3D surface, wherein the plurality of feature maps include at least an X-map approximating an X-coordinate offset and a Y-map approximating a Y-coordinate offset for an item represented by a pixel, and
based on the plurality of feature maps, generate a 3D mesh that approximates the human 3D surface.

20. The system of claim 19, wherein a parameter descriptive of the human 3D surface is approximated by a characteristic of at least one pixel of the extracted contiguous pixels, the parameter being one of: a front spatial location, a back spatial location, a thickness, a base color, and a surface normal.
